(19) United States
(12) Patent Application Publication
(10) Pub. No.: US 2024/0368006 A1
(43) Pub. Date: Nov. 7, 2024

(54) APPARATUS, SYSTEMS, AND METHODS FOR TREATING PER- AND POLYFLUOROALKYL CONTAMINATED FLUIDS

(71) Applicant: ELATEQ, INC., Amherst, MA (US)

(72) Inventor: Ljiljana Rajic, Amherst, MA (US)

(73) Assignee: ELATEQ, INC., Amherst, MA (US)

(21) Appl. No.: 18/596,290

(22) Filed: Mar. 5, 2024

Related U.S. Application Data
(60) Provisional application No. 63/464,335, filed on May 5, 2023.

(51) Int. Cl. C02F 1/461; C02F 1/467; C02F 101/36

(52) U.S. Cl. CPC C02F 1/46109; C02F 1/4672; C02F 1/4676; C02F 2001/46142; C02F 2001/46157; C02F 2101/36; C02F 2201/46105; C02F 2305/026

(57) ABSTRACT

An apparatus for treating PFAS-contaminated fluid includes a housing having an inlet to receive untreated fluid at a first distal end and a outlet for removal of treated fluid at a second distal end, the housing having an open interior. A slip ring is attached to the second distal end and a rotatable shaft located within the open interior is electrically connected to the slip ring. At least one reduction-promoting cathode and anode pair and at least one oxidation-promoting cathode and anode pair are disposed on the rotatable shaft. In use, the at least one reduction-promoting cathode and anode pair and the at least one oxidation-promoting cathode and anode pair are rotated to mix the untreated fluid, and create a reductive process along with an oxidative process to facilitate degradation of PFAS in the untreated fluid.

### CROSS-REFERENCE TO RELATED APPLICATIONS

This application claims priority to U.S. Provisional Application No. 63/464,335 filed on May 5, 2023, which is herein incorporated by reference in its entirety.

### BACKGROUND

### Technical Field

Embodiments of the invention relate generally to techniques for water filtration, and, more specifically, to apparatus, systems, and methods for the treatment of per- and polyfluoroalkyl-contaminated fluids.

### Discussion of Art

Per- and polyfluoroalkyl substances (PFAS), known as “forever chemicals,” are a large class of synthetic chemicals used in a variety of products that have raised significant concerns over adverse impacts on ecosystems and human health. PFAS, which are known to contaminate drinking water, are resistant to breakdown in the environment and the human body. The persistence of PFAS in the environment is due to the strength of C—F bonds in perfluoroalkyl groups (485 kJ mol⁻¹) and a high reduction potential (F+e⁻→F⁻, E^{o}=3.6 V). C—F bonds' selective cleavage is essential for the decomposition of PFAS, but these bonds are among the most stable chemical bonds and cause challenges for PFAS treatment. PFAS shows resilience to known commercial removal processes.

Removal of PFAS by activated carbon and ion exchange resins are the most frequently used “passive” technologies at PFAS-contaminated sites. These processes, however, result in the creation of another stream of waste, the removed PFAS, which necessitates cost- and energy-intensive post-treatment processing. This drawback, among others, has led to the development of “active” or destructive technologies.

Active or destructive technologies include electrochemical oxidation, mechanochemical degradation, pyrolysis and gasification, and supercritical water oxidation, most of which are not commercially available. Although “active” technologies offer promising data, common disadvantages include massive chemical and energy consumption, low cost-efficiency, and incomplete or slow mineralization. These drawbacks will increase with further development and scale-up of these active technologies, including the most promising among them—electrochemical oxidation.

Non-thermal plasma-based PFAS destruction processes have also been proposed. These non-selective processes create multiple reactive species for water treatment (among other uses). However, drawbacks of non-thermal plasma processes include challenges of scale-up and achieving decomposition rates relative to energy efficiency comparable to that of chemical/electrochemical treatments (not only PFAS), electrode corrosion, and the inevitable generation of nitrogen species in aqueous solutions.

Moreover, advanced oxidation processes (AOPs) have been intensively investigated for PFAS degradation, including photolysis, photocatalysis, activated persulfate oxidation, Fenton reaction, and UV-induced oxidation, which have shown moderate PFAS degradation efficiency. These methods' main drawbacks are slow or incomplete defluorination rates.

More recently PFAS degradation processes involving electrochemically-induced oxidation have been proposed. The general advantages of electrochemical treatment systems include (i) in situ creation of oxidation, reduction, or both transformation mechanisms, (ii) easy control of conditions by current adjustments and electrode materials, and (iii) use of renewable power sources. Over the past few decades, it has been shown that electrochemical systems effectively remove and degrade various contaminants.

The oxidation/reduction transformation mechanisms can be supported either through direct electron transfer between the electrode and the compound (reduction or oxidation) or via reactive species created by electrolysis. Anodic oxidation of PFAS has been investigated for various anode materials: graphite-activated carbon fiber, platinum, dimensionally stable anode (DSA) such as Ti/RuO₂, Ti/IrO₂, Ti/SnO₂, and Ti/PbO₂, Magnéli Phase Ti₄O₇, and boron-doped diamond (BDD). Among these, the most effective ones (i.e., BDD) are costly and generate perchlorate ions.

A cost-effective alternative approach is indirect electrochemical oxidation, where ROS are generated in the bulk solution. The most promising processes are electro-Fenton and Fenton-like reactions involving in situ cathodic electro-generation of H₂O₂ via two-electron oxygen reduction (Eq. 1), further activated to ° OH.

O₂+2H⁺+2e→H₂O₂

The most common activation occurs via reaction with Fe (II) (homogeneous or heterogeneous). Homogeneous and heterogeneous electro-Fenton and Fenton-like processes have been studied to degrade various pollutants, including PFAS. In such systems, the proposed PFOA degradation mechanism includes losing one electron to the anode followed by Kolbe decarboxylation, where ° OH oxidizes a formed perfluoroalkyl radical to a shorter chain perfluorocarboxylic acid before being mineralized.

Of particular interest among the indirect electrochemical oxidation processes is a heterogeneous electro-Fenton-like reaction where H₂O₂ is generated by a catalyst-free cathode via two-electron oxygen cathode reduction and activated in the absence of Fe (II). Compared to other electro-Fenton processes where no external oxygen supply is needed (utilizes anodic oxygen), this electro-Fenton-like process also operates under neutral pH.

In addition, attention has been recently focused on advanced reduction processes (ARPs) due to their advantageous effectiveness in destructing PFAS in water. ARPs combine various activation methods and agents to generate reducing radicals (i.e., hydrated electrons or e_{aq}), highly reactive towards oxidized contaminants such as PFAS (F+e⁻→F⁻, E°=3.6 V). The advanced reduction for C—F (and C—C) bond cleavage has been studied using dithionite, sulfite, aqueous iodide, zero-valent iron (ZVI) with vitamin B12, cobalt complexes, ferrocyanide combined with UV, laser flash photolysis, ultrasound, microwave, or radiolytic methods. The proposed transformation pathways via ARPs involve both H/F exchange (C—F cleavage) and chain shortening (C—C cleavage). Still, known ARPs operate under extreme conditions impractical for full-scale applications.

Moreover, heterogeneous catalysts show PFAS defluorination potential since they promote H₂ splitting to sorbed Hₐ, thus converting a C—F bond into the C—H bond (HDF). The examples include Rh on alumina or silica coupled with Pd and Pt loaded as a single atom on SiC substrate. The HDF of fluorinated pharmaceuticals using Pt-group monometallic and bimetallic catalysts on alumina was investigated and successfully employed. However, these approaches require an external supply of H₂ gas, focus mainly on aromatic PFAS, and use costly catalysts (Pt and Rh).

However, studies on PFAS electrochemical degradation rarely discuss the role of cathode processes beyond the electro-Fenton reaction (where it promotes oxidative conditions). Although scarce, few studies show that the cathode processes play a significant role in PFAS defluorination reactions. Some researchers discuss a substantial improvement in defluorination rate using Pt cathode and propose that after the first step of direct electron exchange at the anode, PFOA degradation follows complex reactions with ° OH and Hₐ on the cathode. In another study, Rh-modified Ni foam cathodes have been successfully applied for HDF of 4-fluorophenol in a divided electrochemical cell. These studies show the potential of improving the defluorination rates by proper cathode selection.

Other materials with good catalytic activity, introduced as cathode coatings, could offer a more cost-effective solution for enhanced defluorination. Since the dehalogenation rate is affected by mass transfer, electron transfer, chemical reactions, and surface reactions, such as adsorption and desorption, selecting an appropriate cathode substrate material is important.

What is needed, therefore, is improved apparatus, systems, and methods that provide for cost-effective, chemical-free, scalable, low-power electrochemical removal of PFAS from contaminated water.

### BRIEF DESCRIPTION

In an embodiment, an apparatus for treating PFAS-contaminated fluid includes a housing having an inlet to receive untreated fluid at a first distal end and an outlet for removal of treated fluid at a second distal end, the housing having an open interior, a slip ring attached to the second distal end, a rotatable shaft located within the open interior, the rotatable shaft electrically connected to the slip ring. The apparatus further includes at least one reduction-promoting cathode and anode pair disposed on the rotatable shaft, at least one oxidation-promoting cathode and anode pair disposed on the rotatable shaft. Wherein, in use, the at least one reduction-promoting cathode and anode pair and the at least one oxidation-promoting cathode and anode pair are rotated to mix the untreated fluid. Wherein a reductive process created by the at least one reduction-promoting cathode and anode pair along with an oxidative process created by at the least one oxidation-promoting cathode and anode pair to facilitate the degradation of PFAS in the untreated fluid.

In an aspect, the apparatus further includes an impeller operatively connected to the rotatable shaft, the impeller located proximate to the inlet. Wherein, in use, untreated fluid enters the inlet and rotates the impeller which rotates at least one reduction-promoting cathode and anode pair and the at least one oxidation-promoting cathode and anode pair to mix the untreated fluid.

In an aspect, the at least one reduction-promoting cathode and anode pair and/or the at least one oxidation-promoting cathode and anode pair are configured as blades that are attached to the rotatable shaft.

In an aspect, the at least one reduction-promoting cathode and anode pair and/or the at least one oxidation-promoting cathode and anode pair include a perforated divider separating an anode from a cathode.

In an aspect, the cathode and anode are mesh or fabric.

In an aspect, the at least one reduction-promoting cathode and anode are two blades spaced apart on the rotatable shaft, each blade including a cathode and anode.

In an aspect, the at least one oxidation-promoting cathode and anode are two blades spaced apart on the rotatable shaft, each blade including a cathode and anode.

In an aspect, a power source electrically coupled to the at least one reduction-promoting cathode and anode pair and to the at least one oxidation-promoting cathode and anode pair.

In an aspect, a cathode of the at least one reduction-promoting cathode and anode pair comprises a catalyst-coated carbon-based cathode.

In an aspect, the catalyst-coated carbon-based cathode provides catalytic activity towards a hydrogen evolution reaction and hydrodefluorination.

In an aspect, a cathode of the at least one oxidation-promoting cathode and anode pair comprises a modified carbon-based cathode.

In an aspect, the modified carbon-based cathode includes an oxygen-doped carbon material with functional groups selected to provide an electro-Fenton-like reaction.

In an aspect, the anodes of the at least one reduction-promoting cathode and anode pair and/or the at least one oxidation-promoting cathode and anode comprise TiMMO.

In another embodiment, a method for electrochemical treatment of fluid containing PFAS includes introducing an untreated fluid containing PFAS into an open interior of a housing via an inlet and rotating a shaft located within the housing the shaft being operatively connected to a slip ring and containing a reduction-promoting cathode and anode pair and an oxidation-promoting cathode and anode pair. The method further includes applying an electric field to the reduction-promoting cathode and anode pair and applying an electric field to the oxidation-promoting cathode and anode pair. Wherein a reductive process is created by the reduction-promoting cathode and anode pair followed by an oxidative process created by the oxidation-promoting cathode and anode pair to facilitate the degradation of the PFAS in the untreated fluid.

In an aspect, the shaft includes an impeller located proximate to the inlet. Wherein introducing the untreated fluid into the open interior rotates the impeller which rotates the reduction-promoting cathode and anode pair and the oxidation-promoting cathode and anode pair.

In an aspect, the reduction-promoting cathode and anode pair and/or the oxidation-promoting cathode and anode pair are configured as blades that are attached to the shaft.

In an aspect, the method further includes removing treated fluid from the housing via an outlet.

In yet another embodiment, a system for electrochemical treatment of PFAS-containing fluid includes a housing having an inlet to receive untreated fluid at a first distal end and a outlet for removal of treated fluid at a second distal end, the housing having an open interior, a slip ring attached to the second distal end of the housing, and a rotatable shaft located within the open interior, the rotatable shaft electrically connected to the slip ring. The system further includes at least one reduction-promoting cathode and anode pair disposed on the rotatable shaft, at least one oxidation-promoting cathode and anode disposed on the rotatable shaft, and a pump configured to pump untreated fluid through the inlet into the open interior of the housing. A DC power source is electrically connected to the at least one reduction-promoting cathode and anode pair and the at least one oxidation-promoting cathode and anode pair via the slip ring. Wherein, in use, the at least one reduction-promoting cathode and anode pair and the at least one oxidation-promoting cathode and anode pair are rotated to mix the untreated fluid. Wherein a reductive process created by at least one reduction-promoting cathode and anode pair along with an oxidative process created by at least one oxidation-promoting cathode and anode pair to facilitate the degradation of PFAS in the untreated fluid.

In an aspect, the system further includes an impeller operatively connected to the rotatable shaft, the impeller located proximate to the inlet. Wherein, in use, untreated fluid enters the inlet and rotates the impeller which rotates at least one reduction-promoting cathode and anode pair and the at least one oxidation-promoting cathode and anode pair to mix the untreated fluid.

### BRIEF DESCRIPTION OF THE DRAWINGS

The present invention will be better understood from reading the following description of non-limiting embodiments, with reference to the attached drawings, wherein below:

FIG. 1 is a simplified schematic diagram of a system for the electrochemical treatment of PFAS-contaminated fluid according to an embodiment of the invention;

FIG. 2 is a perspective view of an apparatus for treating PFAS-contaminated fluid, suitable for use in the system of FIG. 1, according to an embodiment of the invention;

FIG. 3 is a perspective view of the apparatus of FIG. 2, with a housing removed;

FIG. 4 is a cut-away view of the apparatus of FIG. 1;

FIG. 5 is a perspective view of a rotatable shaft with two reduction-promoting cathode and anode pairs and two oxidation-promoting cathode and anode pairs according to an embodiment of the invention;

FIG. 6 is a sectioned view of the rotatable shaft of FIG. 5;

FIG. 7 is a side view of an impeller according to an embodiment of the invention;

FIG. 8 is an end view of the impeller of FIG. 7;

FIG. 9 is a chart of PFOA and PFOS removal by oxidation and reduction only according to embodiments of the invention;

FIG. 10 is a chart of PFOA removal by oxidation, reduction, and combinations thereof according to embodiments of the invention;

FIG. 11 is a chart of PFOA and PFOS removal by oxidation, reduction, and combinations thereof according to embodiments of the invention;

FIG. 12 is a chart of cumulative short-chain PFAS by oxidation, reduction, and combinations thereof according to embodiments of the invention;

FIG. 13 is a chart of PFOA removal by various coated and uncoated materials according to embodiments of the invention;

FIG. 14 is a chart of PFOA removal materials with and without coatings according to embodiments of the invention;

FIG. 15A is an illustration of a base portion and inlet of the apparatus of FIGS. 2 and 3;

FIG. 15B is an illustration of a shaft and cathode and anode pairs of the apparatus of FIGS. 2 and 3;

FIG. 15C is an illustration of a slip ring of the apparatus of FIGS. 2 and 3;

FIG. 15D is an illustration of a housing the apparatus of FIGS. 2 and 3;

FIG. 15E is an illustration of another component of the apparatus of FIGS. 2 and 3;

FIG. 16A is an illustration of a system that includes multiple reactors according to an embodiment of the invention.

FIG. 16B is another illustration of a system that includes multiple reactors according to an embodiment of the invention.

FIG. 16C is yet another illustration of a system that includes multiple reactors according to an embodiment of the invention.

### DETAILED DESCRIPTION

Reference will be made below in detail to exemplary embodiments of the invention, examples of which are illustrated in the accompanying drawings. Wherever possible, the same reference characters used throughout the drawings refer to the same or like parts, without duplicative description.

As used herein, the terms “substantially,” “generally,” and “about” indicate conditions within reasonably achievable manufacturing and assembly tolerances, relative to ideal desired conditions suitable for achieving the functional purpose of a component or assembly. The term “real-time” means a level of processing responsiveness that a user senses as sufficiently immediate or that enables the processor to keep up with an external process.

Additionally, while the embodiments disclosed herein are primarily described with respect to water treatment/purification, it is to be understood that embodiments of the invention may be applicable to other types of filtration processes involving liquids other than wastewater. As used herein “fluid” includes water and other treatable liquids. While embodiments are described in connection with the treatment of PFOA or PFOS, embodiments are not so limited and are suitable for the removal of a wide variety of PFAS.

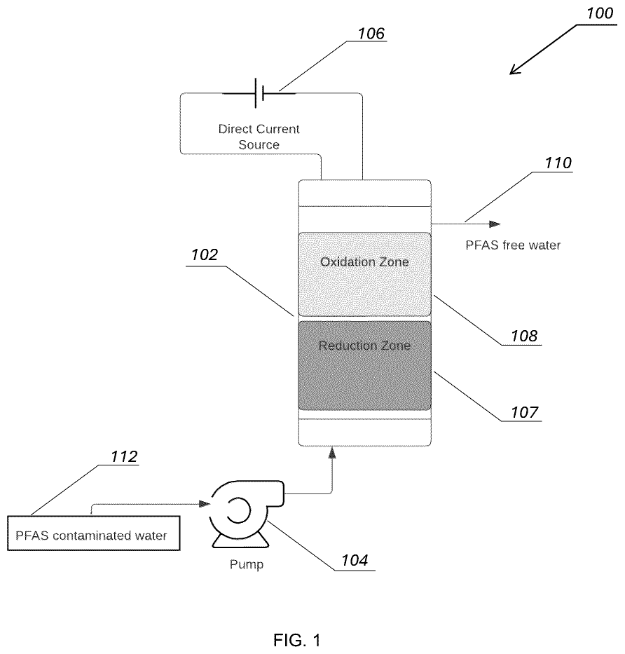

Referring now to FIG. 1, a system for electrochemical treatment of PFAS-contaminated fluid, e.g., water, is depicted in simplified schematic form. The system 10 generally includes a treatment apparatus, i.e., a reactor/continuous flow cell, (apparatus 102), that is fluidly connected to a source 112 of untreated PFAS-contaminated fluid via a pump 104. The pump 104 is fluidly connected via tubing or similar conduit to the source 112 and to an inlet of the reactor. The system 10 further includes a power source 106, such as a DC current source, which, as described in greater detail below, is electrically connected to cathode and anode pairs located within the reactor.

As shown, the reactor has a reduction zone 107, in which at least one reduction-promoting cathode and anode pair contacts and treats the untreated fluid, and an oxidation zone 108 in which at least one oxidation-promoting cathode and anode pair contacts and treats the untreated fluid. As described in detail below, the combination of a reductive process and an oxidative process, created by the cathode/anode electrode pairs, on PFAS-contaminated fluid has shown effective results at degrading PFAS.

The system 100 further includes an outlet in which treated fluid can exit the reactor. As will be appreciated, the treated fluid 110 may exit via tubing fluidly connected to a variety of storage receptacles, e.g., tanks, bags, and the like. In certain embodiments, the system 100 may be fluidly connected to additional downstream equipment (not shown) so that the treated fluid 110 may be further processed.

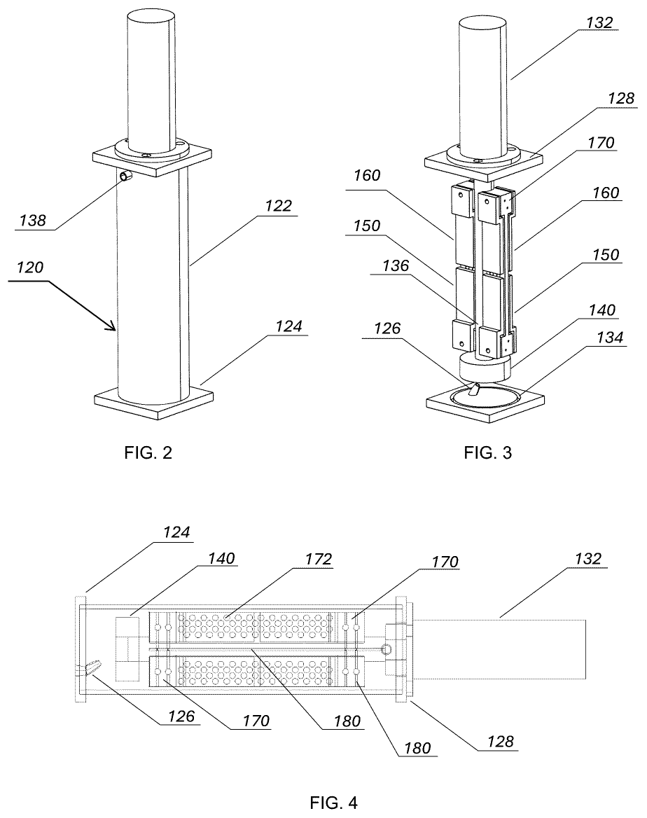

Referring now to FIG. 2, FIG. 3, and FIG. 4, an apparatus for treating PFAS-contaminated fluid (and suitable for use in the above-described system) according to an embodiment of the invention is depicted. The apparatus 120 includes a housing 122 that is generally cylindrical, though, in embodiments, other shapes may be suitable. The housing 122 has a open interior (not shown). The housing 122 includes end caps on opposite distal ends of the housing 122. The end caps include an inlet end cap 124, which contains an inlet 126 for receiving untreated PFAS-containing fluid via the pump 104, and a slip ring end cap 128 which is configured to receive slip ring 132. The end caps may each include a recess 134 configured to receive distal end of the housing 122. As will be appreciated, the housing 122 should be fixed to the end caps such that fluid in the open interior cannot escape during use. As such, the end caps may be attached using chemical sealants and the like and/or gaskets. In embodiments, the housing and end caps may be unitary.

As shown, the housing 122 also includes a outlet 138 for removal of treated fluid. The outlet 138 is located at a second distal end of the housing, opposite the first distal end to which the inlet end cap 124 is attached.

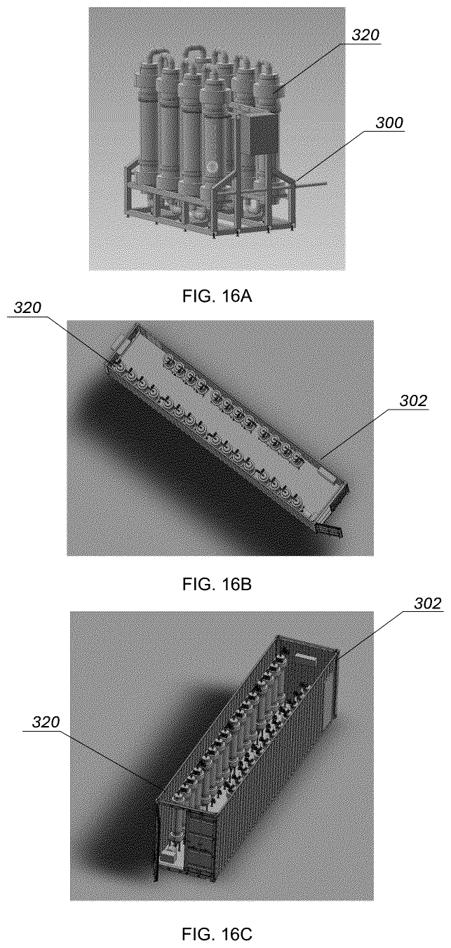

In the depicted embodiment, the end caps are square/rectangular and are substantially equal in size so that they form a flat base so that the reactor may be horizontally placed/oriented (FIG. 4). Of course, as will be appreciated, the apparatus 120 need not be horizontally oriented and in embodiments, the apparatus 120 may be vertical/upright during use and may include an external support structure. In certain embodiments, multiple apparatus may interconnected in an upright orientation and and contained within a support structure (FIG. 16A, FIG. 16B and FIG. 16C). As such, in embodiments, the end caps need not be square/rectangular and need not form a flat base for horizontal orientation.

Referring to FIG. 3 and FIG. 4, apparatus 120 includes a rotatable shaft 136 which is rotatably and electrically connected to slip ring 132. The rotatable shaft 136 features at least one reduction-promoting cathode and anode pair 150 and at least one oxidation-promoting cathode and anode pair 160. As depicted, in embodiments, the at least one reduction-promoting cathode and anode pair and/or the at least one oxidation-promoting cathode and anode pair are configured as blades or paddles that are disposed on the rotatable shaft. In specific embodiments, the at least one reduction-promoting cathode and anode and/or the oxidation-promoting cathode and anode pair are in the form of two blades spaced apart on the rotatable shaft. That is, each of the two blades includes an oxidation-promoting cathode and anode and a reduction-promoting cathode and anode. Although depicted and tested with two such blades, embodiments may have more than two blades. There may be up to four total blades disposed on the rotatable shaft.

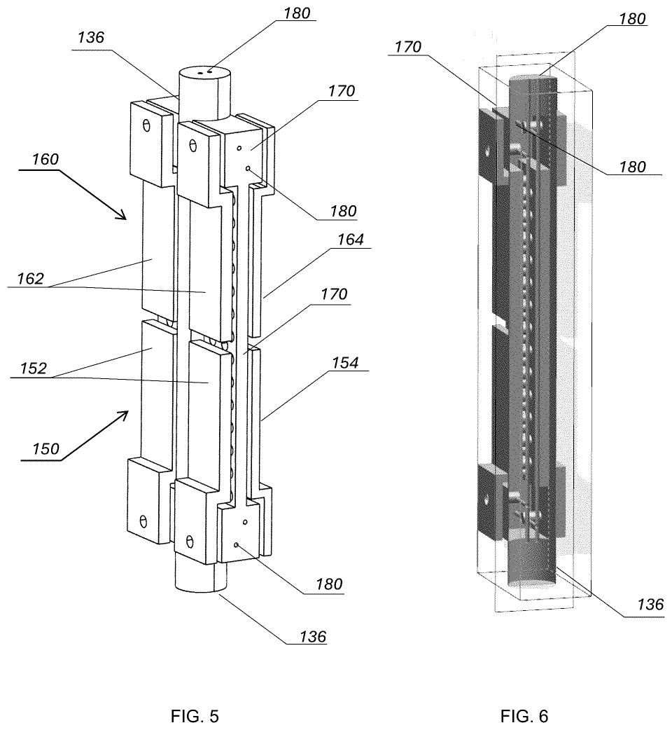

Referring to FIG. 4, FIG. 5 and FIG. 6, the at least one reduction-promoting cathode and anode pair 150 includes a cathode 152 and an anode 154. The cathode and anode in each pair may be separated by a perforated divider 170 that includes a series of perforations 172 that allow fluid to pass through the cathode and anode. The at least one oxidation-promoting cathode and anode pair 160 includes a cathode 162 and an anode 164 which are also separated by the perforated divider 170.

While depicted as solid materials, in embodiments, the cathode, anode, and divider may be comprised of a mesh or fabric to facilitate fluid passage. In other embodiments the cathode and anode may be of other perforated material. The perforated divider 170 may be attached to the rotatable shaft via mechanical fasteners or chemical fasteners. In embodiments, the divider and shaft may be unitary. The perforated divider 170 may function as a holder for the cathode and anode. That is the cathode and anode may be secured to the divider via mechanical fasteners, such as Ti grade 2 or TiMMO screws, which may be of a variety of other materials as long as they are corrosion-resistant and inert. In use, when the shaft rotates the divider with the attached cathodes and anodes rotate and the blades formed by the cathodes and anodes mix/mix fluid in the open interior of the housing.

In a specific embodiment, the cathode 152, 162 has a thickness of about 3 mm, the perforated divider has a thickness of about 3 mm and the anode has a thickness of about 2 mm. With the blade or paddle having a length of about 1.27 cm. In an embodiment, the perforations in the divider are round and have a diameter of about 2.8 mm. As will be appreciated, these dimensions may vary without departing from the scope of the invention.

In embodiments, a cathode of the at least one reduction-promoting cathode and anode pair promotes a reduction reaction. In specific embodiments, the cathode includes a catalyst-coated carbon-based cathode which provides catalytic activity towards a hydrogen evolution reaction and hydrodefluorination. In embodiments, a cathode of the at least one oxidation-promoting cathode and anode pair promotes an oxidation reaction. Specific embodiments include a modified carbon-based cathode that may include an oxygen-doped carbon material with functional groups selected to provide an electro-Fenton-like reaction. As will be appreciated, other materials may be utilized without departing from the scope of the invention.

In embodiments, the anodes of the at least one reduction-promoting pair and/or the at at least one oxidation-promoting pair include TiMMO.

The cathodes and anodes of the reduction-promoting pair and the oxidation-promoting pair may be connected to a power source, e.g., power source 106 (DC) via Ti grade 2 or TiMMO wiring in the rotatable shaft and the divider which is electrically connected to the slip ring 132. The electrification path/wiring is depicted as wiring 180 in the figures, e.g., FIG. 4, FIG. 5, and FIG. 6.

In embodiments, the cathode and anode pairs for the oxidation and reduction processes both operate under the same constant current and the design allows for a shared connection to the DC source via slip ring. When scaling embodiments of the invention, the current will be applied to maintain the optimum current density. The cathode and anode pair dimensions will increase as the apparatus scales up keeping the ratio with flow cell size. The TiMMO anode thickness will remain at 2 mm and other anode materials can be used.

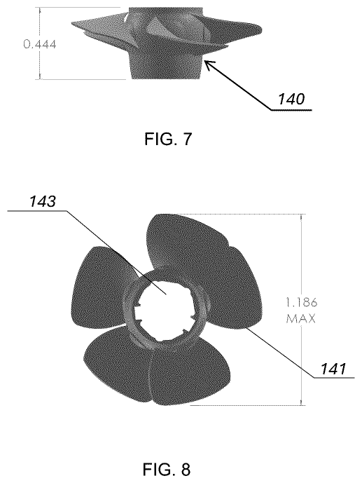

Referring now to FIG. 4, FIG. 7, and FIG. 8, in an embodiment, an impeller 140 is operatively connected to the rotatable shaft 136 the impeller 140 is located proximate to the inlet 126. The impeller 140 (i.e. turbine), may be a Kaplan-type turbine. While the figures have dimensions (in inches) from a specific embodiment, e.g., a diameter of 1.186 in, which was tested in the results summarized herein, the dimensions may vary based on fluid volumes and the like. For scaling purposes, the impeller dimensions and fluid inlet position and dimensions should scale by keeping the ratio with the overall apparatus dimensions. Different types of blade designs and angles can be used depending on the flow.

In embodiments that include impeller 140, untreated fluid entering the open interior of the housing through the inlet 126 contacts the blades of the impeller 140 causing rotation of the rotatable shaft which rotates the at least one reduction-promoting cathode and anode pair and the at least one oxidation-promoting cathode and anode pair to mix the untreated fluid. In alternative embodiments, it may be possible for the shaft to be rotated via a motor (not shown) and the apparatus 120 may omit the impeller. As will be appreciated, use of an impeller 140 may provide power consumption benefits when compared to use of a motor to rotate the shaft.

Various components of the apparatus 120, e.g., the housing, end caps, divider, and impeller, may be manufactured from a variety of materials including polymeric materials (plastics) and like. For example, the materials that can be used are poly (methyl methacrylate) (plexiglass or acrylic), polyvinyl chloride (PVC), chlorinated polyvinyl chloride (CPVC), for the housing 122 or polypropylene for the divider and impeller (FIG. 3). Though Teflon-based materials may be unsuitable. Likewise the various components may be manufactured using a variety of techniques e.g., additive processes, without departing from the scope of the invention.

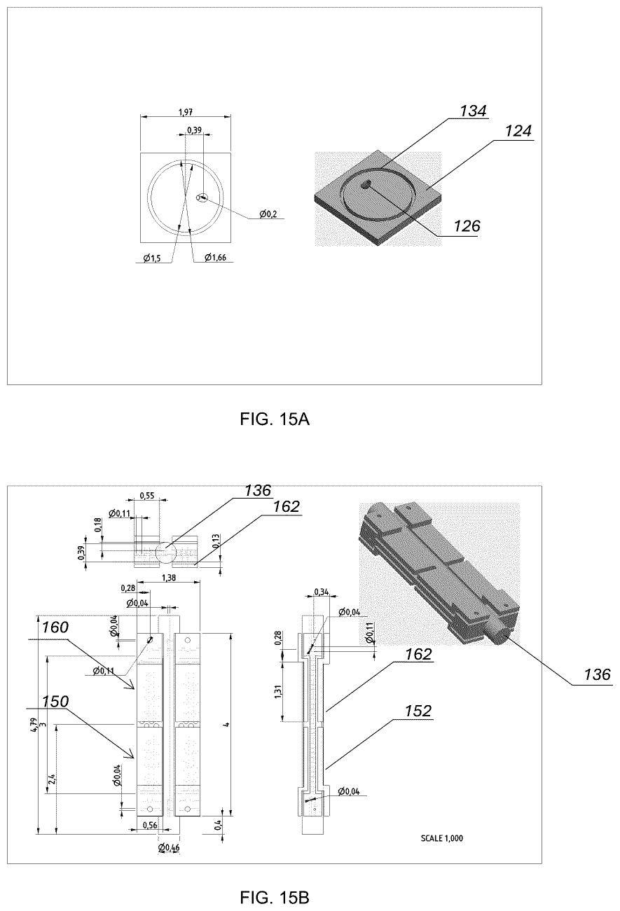

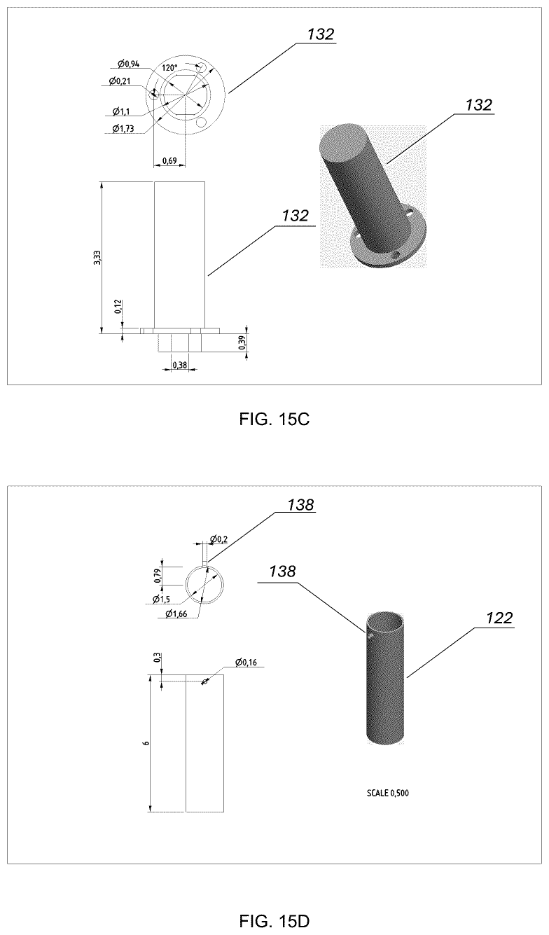

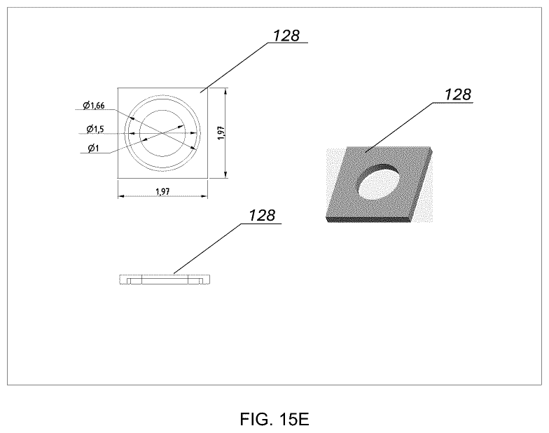

Referring to FIG. 15A, FIG. 15B, FIG. 15C, FIG. 15D, and FIG. 15E, the dimensions of various components of an embodiment are depicted in inches. The dimensions of the apparatus may vary, however, the scale-up should keep the diameter vs length ratio and the inlet and outlet locations relative to the flow cell size should be kept at the same ratio.

With respect to the slip ring 132, various designs and specifications (i.e., max. current, voltage) may be employed as the apparatus 120 scales up to meet the treatment capacities. In embodiments, the slip ring 132 can be the nonsubmersible type since the location of the outlet keeps the fluid level below the slip ring. This flexibility is beneficial since submersible slip rings have a significant rotation resistance due to the use of sealant causing turbine rotation to cease under lower slow rates.

Referring now to FIG. 16A, FIG. 16B and FIG. 16C, in embodiments, the apparatus/reactors of the invention can be scaled up to 30.5 cm diameter, 1.2 m tall reactors with a capacity to treat up to 60 liters per minute. These apparatus 320 can be arranged as two treatment units up to a module 300 of eight such apparatus connected in two parallels and then four in series. For higher capacities of treatment, modules 300 can be multiplied. Another arrangement includes a containerized system 302 of twenty-eight reactors of the same size as mentioned above.

Embodiments of the invention contemplate methods for electrochemical treatment of fluid containing PFAS includes introducing an untreated fluid containing PFAS into an open interior of a housing via an inlet and rotating a shaft located within the housing the shaft being operatively connected to a slip ring and containing a reduction-promoting cathode and anode pair and an oxidation-promoting cathode and anode pair. The method further includes applying an electric field to the reduction-promoting cathode and anode pair and applying an electric field to the oxidation-promoting cathode and anode pair. Wherein a reductive process is created by the reduction-promoting cathode and anode pair followed by an oxidative process created by the oxidation-promoting cathode and anode pair to facilitate the degradation of the PFAS in the untreated fluid. In an embodiment, the shaft includes an impeller located proximate to the inlet. Wherein introducing the untreated fluid into the open interior rotates the impeller which rotates the reduction-promoting cathode and anode pair and the oxidation-promoting cathode and anode pair.

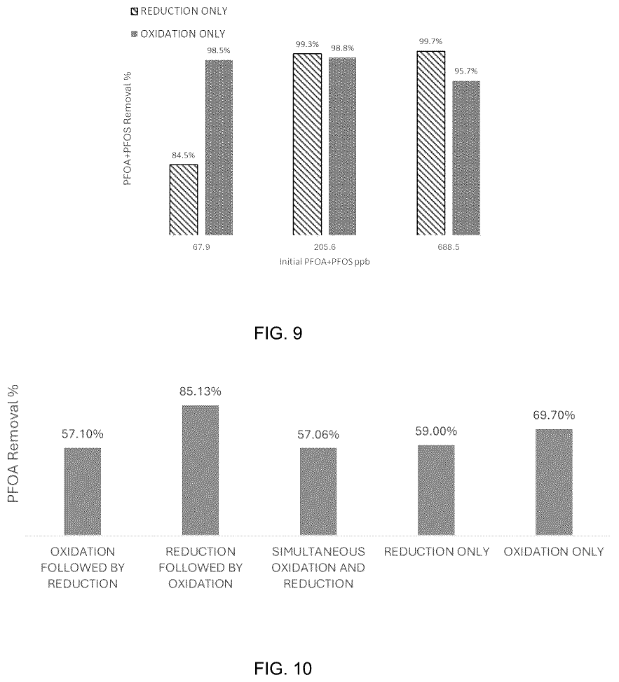

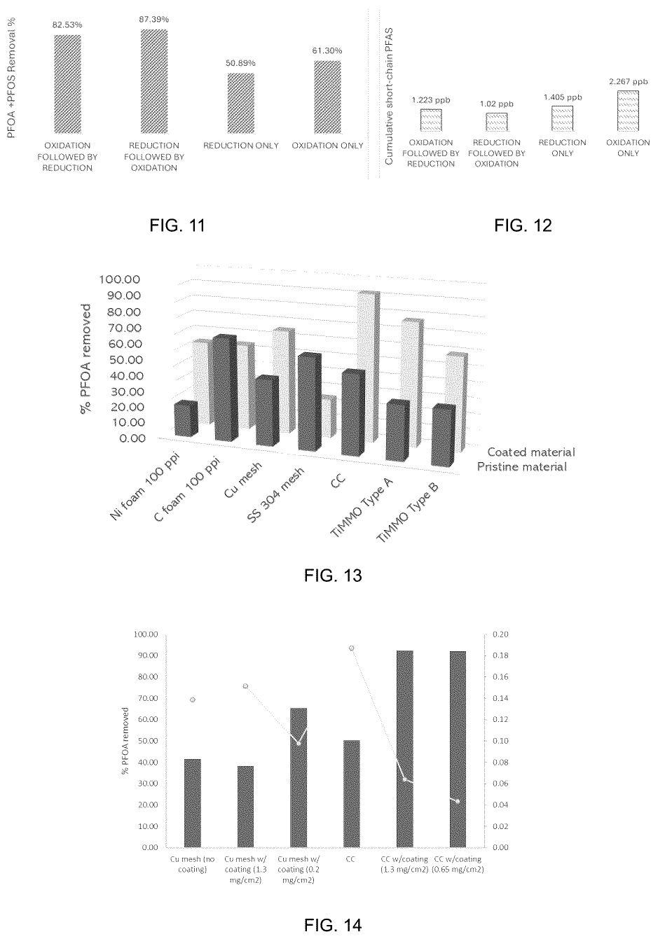

Embodiments of the invention have undergone testing and demonstrated that a reductive process and an oxidative process, created by the cathode/anode electrode pairs pursuant to the invention, on PFAS-contaminated fluid has shown effective results at degrading PFAS. Results of testing of embodiments are shown in FIG. 9, FIG. 10, FIG. 11, FIG. 12, FIG. 13, and FIG. 14.

### Cathode Optimization for the Reductive Process

Applicant demonstrated superior performance of catalyst-coated cathodes based on the PFOA and PFOS defluorination rates. The developed coated carbon cloth cathode nearly doubled the removal rate with 4.5 less energy use than other tested substrates and showed no leaching of metals or coating during the use.

With respect to reduction-promoting cathodes, various electrode substrate materials were used for testing, including operating parameters such as electrode area, current intensity, mixing rates, and coating load. The coating procedure was optimized and confirmed using the following instruments: ICP-MS, XRF, and Cyclic Voltammetry. The coating procedure of the carbon cloth substrate material was performed in the electrochemical cell using a proprietary coating solution. The procedure consisted of constant current application at 50 mA for a 10-minute duration and 200 rpm mixing. The ratio between the electrode area and the electrolyte solution volume was 10.5, and the interelectrode distance between the active electrodes was 1.5 cm. The current collector for all coated electrodes (where used) was titanium-based mixed metal oxide (TiMMO) mesh, where substrate material was secured uniformly around the current collector (when carbon cloth was used). The analysis of PFOA, PFOS, and short-chain fluorinated PFAS byproducts such as pentafluorobenzoic acid (PFBA), perfluoropentanoic acid (PFPeA), perfluorohexanoic acid (PFHxA), perfluoroheptanoic acid (PFHpA), perfluorononanoic acid (PFNA), perfluorodecanoic acid (PFDA), perfluoro-n-undecanoic acid (PFUdA), perfluorododecanoic acid (PFDoA), perfluorobutanesulfonic acid (PFBS), perfluoropentane sulfonic acid (PFPeS), perfluorohexane sulfonate (PFHxS), pentadecafluoro-1-heptanesulfonic acid (PFHpS), perfluorononanesulfonic acid (PFNS), perfluorodecane sulfonic acid (PFDS), and perfluorooctanesulfonamide (PFOSA) was performed. The tests were conducted in the 50 mL batch reactors with magnetic stirring (glass-coated magnetic stirrer) and with PFOA or PFOA+PFOS concentrations of >100 ppb in an electrolyte containing sodium sulfate with the conductivity of 1.2 mS/cm unless noted otherwise. The anodes used in all the tests were TiMMO mesh.

After testing various substrates and operational parameters, the data showed superior performance of coated carbon cloth (CCC) material (proprietary). FIG. 13 shows variation in the impact of coating load dependent on the substrate material (the data shown is related to PFOA removal only with the initial concentration of 119 ppb) conducted in 30-minute tests and indicates the significant impact of the coating on carbon cloth (CC) material performance. The efficiency nearly doubled by CCC compared to the pristine CC material. The degradation rate of treatment with CCC compared to other reported, promising electrochemical oxidation systems show a significantly faster degradation rate, while other HDF processes reported indicated up to 90 days of treatment.

FIG. 14 shows the impact of coating on the energy consumption (as kWh/g of PFOA removed, including the energy used for the coating process), indicating that CCC uses nearly 4.5 times less energy than other tested materials, including uncoated carbon cloth. Additional testing was conducted to confirm the stability and longevity of the electrodes, which showed that CCC has nondetectable levels (or below regulatory levels) of all metals regulated for drinking water (Pb, Cd, Al, Cr, Mn, Fe, Co, Ni, Cu, Zn, As, TI, Se, Ba, Be, Hg, and Sb). We tested other substrates not presented in FIG. 13 (several types of GAC, Ni—Cu, SS 316, and carbon-based foams), which showed significant leaching of metals indicated above. The stability of the coating was tested by running experiments with the same cathode more than 3 times with no changes in the efficiency, electrode coating, and without leaching into the solution.

While testing the removal of 196 ppb of initial PFOS+PFOA in the mixture, using CCC (conducted in the 50 mL batch reactors, with sodium sulfate solution of 1.2 mS/cm and current intensity of 50 mA), data showed 92% removal of PFOA+PFOS. The CCC application alone shows the presence of the tested short-chain byproducts, indicating the incomplete defluorination by reduction process only, which was additionally confirmed by the fluoride release of approx. 50%.

The data shows that the sorption of PFOA onto CCC contributes to 47% of removal (similar to the uncoated CC removal rate). The sorption of the present short-chain byproducts in the initial PFOA+PFOS solution was negligible. However, sorption tests alone (no current applied) do not present the same characteristics of the material as when the material is used as an electrode. The effects of charge and bubble accumulation from water electrolysis significantly change the interactions between molecules and material, and sorption capacity without current application is not directly translatable to the conditions when current is applied.

Based on the results from tests including Cyclic Voltammetry, ICPMS, short-chain PFAS byproducts analysis, and XRF, the main mechanism involved with CCC is primarily hydrodefluorination. The combination of the hydrophobic characteristics of the substrate material leading to moderate sorption capacity and hydrogen generation affinity of transitional metals used for the coating while operating at the H₂ generation potentals, support the HDF steps. The intermediates indicate that HDF is accomplished via stepwise and parallel reactions on the cathode surface.

We also tested CCC for the impacts of water hardness (61-120 mg/L as CaCO₃), and chloride presence (conducted in the 50 mL batch reactors, with sodium sulfate solution of 1.2 mS/cm and current intensity of 50 mA). The data showed <10% impact of the water hardness on the cathode performance, while chloride presence showed no impact on the performance (free chlorine was not detected).

The electrochemical tests were performed under current intensities that support H₂ evolution at the cathode in the 50 mL batch reactors, with a sodium sulfate solution of 1.2 mS/cm. Current intensities were varied to test the impact of the current density on the cathode performance. In addition, electric field application modes, electrode area-to-volume ratio optimization, and mixing rates were evaluated. These tests were done by using TiMMO Type B coated cathode.

The impacts of the current increase (50 mA to 100 mA) and mixing increase (100 to 200 rpm) show the improvement of >20% PFOA degradation rate. However, the 100 mA showed a rapid trend of voltage increase during the treatment confirming the rise of resistivity due to bubble accumulation (gasses produced by water electrolysis).

The electric field application modes, such as pulsed electric field, were tested to reduce the repulsion between negative cathode charge and negative PFAS head group. The pulsed electric field did not show improvement in the removal rates and caused significant leaching of coating material, which was expected due to transient currents.

Optimizing mixing rates are crucial for proper mass transfer of chemical species to and from the cathode, minimizing gas bubble coverage at the electrode surface and enabling sorption of PFAS to the cathode.

Applicant demonstrated that enhanced defluorination and mineralization rates in PFOA and PFOS by integrated transformation mechanisms (reduction and oxidation integrated) vs. advanced reduction or oxidation alone. In particular, a reductive process followed by an oxidative process showed surprisingly higher efficiencies vs. all variations in the transformation processes alone or other sequential and simultaneous use modes.

### Cathode Optimization for the Oxidation Process

Various electrode carbon materials were used for the modification, and tests included: a) optimization of the modification process, b) selection of proper carbon material for maximum production of hydroxyl radicals (inducing advanced oxidation process), and c) optimization of the operating parameters such as electrode area, and mixing rates. The modification procedure was tested and confirmed using the following instruments: ICP-MS and FTIR were performed. The modification procedure of the substrate material was performed in the electrochemical cell using an electrolyte solution and modification procedure. The ratio between the electrode area and the electrolyte solution volume was 10.5, and the interelectrode distance between the active electrodes was 1.5 cm. The current collector for all modified electrodes (where used) was TiMMO mesh, where substrate material was secured uniformly around the current collector. The analysis of PFOA, PFOS, and short-chain PFAS byproducts was performed. The analysis of benzoic acid (radical scavenger) was conducted using the UV/VIS spectrophotometer, and peroxide concentration analysis was performed using the Hach testing kit. The tests were conducted in the 50 mL batch reactors (magnetic stirrer), with a sodium sulfate solution of 1.2 mS/cm as an electrolyte and current intensity of 50 mA. The anodes used in all the tests were TiMMO mesh.

Other tested carbon materials (carbon foam, graphite felt, several GAC types) and their modifications were excluded based on the lesser efficiency for 196 ppb initial PFOA+PFOS transformation than modified carbon cloth cathode (MCT) (proprietary, differently modified carbon cloth, same substrate as used for coating) and ease of preparation and material handling. The 30-minute tests further showed that MCT has a superior performance for removing 99.7% of PFOA+PFOS compared to pristine carbon cloth, which achieved 65.9% removal of PFOA+PFOS. Still, it was found that the sorption with MCT significantly aids in removing both PFOA+PFOS and short-chain molecules (approx. 60% while >99% with pristine carbon cloth), and the fluoride release was approx. 25%. Compared to CCC performance, the fluoride release was significantly lower, indicating that the oxidation step, while showing similar removal efficiency, does not provide superior mineralization of PFOA and PFOS at a significant rate. The stability of the MCT was tested by running experiments with the same cathode more than three times with no changes in the overall efficiency.

Based on the results from tests including FTIR and hydrogen peroxide, hydroxyl radicals, and short-chain PFAS byproducts analysis, we proposed that the main degradation mechanism involved with MCT is a primarily electro-Fenton-like reaction. The modification process increases the hydrophilic properties of the MCT, which directly impacts the access of dissolved oxygen to produce hydrogen peroxide. Further, activating hydrogen peroxide to hydroxyl radicals enables oxidation in bulk. The tests on confirming the hydrogen peroxide activation to hydroxyl radicals vs. degradation to H₂O using benzoic acid as a radical scavenger were conducted using modified and non-modified carbon cloth material. The tests confirmed that the MCT material produces 4 times more hydroxyl radicals than non-modified material by generating and activating the hydrogen peroxide.

The oxidation step of PFAS can be adversely affected by the co-contaminants' presence, especially NOM. Such influence was tested by adding humic substances to the synthetic groundwater. Humic acid was added to the solution in concentrations of 0.1, 1.0, and 10.0 ppm, and data showed that the influence was negligible (<6%). Another set of tests with the presence of bicarbonate and carbonate ions as sodium salts showed that the PFOA+PFOS removal rates were not significantly (<10%) impacted by their presence. Being inorganic radical scavengers, the impact of bicarbonate and carbonate ions under tested concentrations also indicate the impact of hydroxyl radicals on the overall PFAS removal rates, while low impacts indicate the abundance of hydroxyl radicals generated by MCT.

The impact of initial PFOA+PFOS concentration on the individual reductive and oxidative processes, supported by CCC and MCT, respectively, is presented in FIG. 9. The reduction process can play a significant role in PFAS degradation for PFOA+PFOS concentrations >100 ppb, while the oxidation process is less impacted by the concentration variations. This is caused by the fact that the reductive process occurs at the cathode surface, which is directly impacted by the mass transfer. This data indicates that the reductive process will be significant for wastewater treatment and other higher PFAS-concentration-containing streams and explains the difference in the data on different tests provided in the next sections.

### Integrated Reduction and Oxidation Processes

As we optimized the electrode substrate for each process, modification and coating protocols and operating conditions, primarily current intensity and electrode design of the carbon cathodes for reduction and oxidation processes, we further determined the following:

The novel concept of integrating both advanced reductive and oxidative processes and tested the hypothesis that reduction followed by oxidation offers the most effective PFAS degradation process.

The oxidation-promoting cathode and anodes and the reduction-promotion cathode and anodes were designed as electrode pairs, also referred to as TEPs (tight electrode packs) intending to ensure modularity in integrating these reactive packs at the flow electrochemical flow cell.

The novel mixing function via the rotatable shaft and blades/paddles with integrated TEPs for advanced mass transfer, is essential for adequate flow cell performance and bubble (gasses produced during water electrolysis) accumulation control.

### Integrated Advanced Reduction and Oxidation Process

The novel concept of integrating both advanced reduction and oxidation processes was tested to assess the most effective degradation process. The initial tests were conducted in the 50 mL batch reactors, with a sodium sulfate solution of 1.2 mS/cm and current intensity of 50 mA with solely PFOA concentrations of 49.5 ppb. We tested advanced sequential reduction followed by advanced oxidation, advanced oxidation followed by advanced reduction, and simultaneously integrated process.

FIG. 10 shows results from tests conducted over a total of 30 minutes of treatment with coated TiMMO Type B (reduction) and modified graphite felt (oxidation, electro-Fenton-like process), which were the initial tests on integrated oxidation and reduction processes. The duration of the simultaneous reduction and oxidation-only tests was 30 minutes, while the reduction followed by the oxidation and the oxidation followed by the reduction was set at 15 min for each sequence of reduction and oxidation (totaling 30 minutes).

The data shown in FIG. 10 confirms that reduction followed by advanced oxidation achieves the most efficient performance. Also, the data indicates >85% fluoride release after reduction, followed by oxidation with TiMMO Type B and modified graphite, which was not achieved by other integrated or sole process applications tested.

### Electrode Pair/Pack Design

Testing was done on the optimized CCC and MCT cathodes in the 50 mL batch reactors, with sodium sulfate solution of 1.2 mS/cm and current intensity of 50 mA. The design of electrode pairs (FIGS. 2-5) was intended to ensure modularity in integrating these reactive packs in the electrochemical flow cell. The tight electrode packs (TEP) with 3 mm interelectrode distance were designed and tested for PFOA+PFOS removal using CCC and MCT cathodes. The TEP was performed under the same conditions as tests conducted during cathode optimization steps for both CCC and MCT and showed=0.5% of the variation in the removal rate for PFOA+PFOS as when the interelectrode distance was 2.5 cm in the 50 mL batch reactor. The only operational difference was the mixing rate of 600 rpm since the preliminary testing showed limited performance at 200 rpm, which showed no impact in the 50 mL batch reactor with an interelectrode distance of 2.5 cm. This, again, is caused by the bubble entrapment in TEP. The TEP design was developed to allow modularity in the electrochemical flow cell, and these tests were initially performed on the individual reduction and oxidation process.

### Mixing Component Design

The novel mixing component with integrated cathode and anode pairs (e.g., TEPs) was developed for advanced mass transfer, essential for adequate flow cell performance. As shown, the mixing has a crucial impact on the degradation processes studied here and has a dual purpose: improved mass transfer of PFAS molecules to/from the electrode surface and bubbles detachment. The tests presented here were conducted in the 350 mL batch reactors under 200 rpm, and an increased electrode area-to-volume ratio of 47 (was 11 in 50 mL batch) using solely sodium sulfate solution of 1.2 mS/cm and solely PFOA or PFOA+PFOS in sodium sulfate solution of 1.2 mS/cm.

The types of mixing modes and components are (the details on the design are not disclosed here) magnetic stirring with stationary paddle containing two TEP secured on the paddles (MS-TEP), DC motor-driven mixing paddle with two TEP on the cell walls (SD-TEP), and DC motor-driven mixing paddle with two TEPs secured on the paddles/blades (PE-TEP).

The preliminary tests of comparing rotating blades with tight electrode packs, i.e., PE-TEP vs. stationery were done in sodium sulfate solution of 1.2 mS/cm, where production and activation of hydrogen peroxide (electro-Fenton-like process) were monitored. These preliminary tests, mainly peroxide generation, were chosen as a rapid and cost-effective way to optimize some of the design and operational parameters: paddle design, TEP positioning, mechanical electrode stability, and overall apparatus for PE-TEP such as effective connections to DC source, and DC motor for paddle rotation calibration.

The data shows hydrogen peroxide formation of 1, 2, and 6 for MS-TEP, SD-TEP, and PE-TEP, respectively. The tests were conducted with the initial PFOA+PFOS concentration of 195 ppb and indicate that PE-TEP can achieve similar efficiencies as MS-TEP comparing each oxidation (99.5% vs. 99.9%) and reduction process (96.3% vs. 99.3%). The data on each process removal rate and reduction followed by oxidation by PE-TEP are shown in FIGS. 11 and 12. The data is presented for the removal efficiency of initial PFOA+PFOS concentration of 39.3 ppb levels and cumulative short-chain PFAS molecules levels after the treatment. In agreement with the tests conducted on PFOA only by other cathode materials than CCC and MCT (FIG. 4), reduction followed by oxidation achieves higher fluoride release (in this case >90%), which was not achieved by other tested individual and integrated processes.

Treatment using optimized reduction followed by oxidation by CCC and MCT with a higher concentration of 205.6 ppb PFOA+PFOS resulted in a 99.5% removal rate, >90% of fluoride release, 31% non-detected byproducts and cumulative of 0.2 ppb short-chained PFAS byproducts tested. The differences in the achieved total removal efficiencies are evident and are caused by the variations in the initial PFOA+PFOS concentrations. The optimized sequential use of CCC and MCT electrodes outperforms on all or some of the following characteristics compared to other reported, promising electrochemical oxidation systems: significantly faster degradation rate (i.e., 85-fold increase), improved mineralization rates (only one reported system with 90%), higher electrode area-to-volume (47 vs. 2.5) and lower electrode costs (>20 times more cost-effective than Ti₄O₇).

The significant energy savings on the electrochemical processes alone were achieved by PE-TEP vs. MS-TEP: approx. 85% energy savings for the oxidative step and approx. 75% energy savings for the reductive step when power consumption for mixing is excluded, while energy savings of 35% in the oxidation step, and 13% in the reduction step were achieved when the power requirement for mixing is included.

The apparatus and system depicted in FIGS. 1-8 was tested achieving the <70 ng/L as final concentrations for PFOA+PFOS, with low initial concentrations, which were chosen since the batch reactor's performance was incomplete for such levels of PFAS tested. The electrochemical flow cell was designed to operate under 1.7 kWh/m³. The developed mixing device, as used in PE-TEP, was used in apparatus 102 for the reduction followed by an oxidation sequence for degradation of PFOA+PFOS in the concentrations of 115.5 ppt PFOA+PFOS. The FC-TEP (apparatus 102) operated as two continuous flow cell recirculation units (only for testing purposes flexibility), identical in design but containing CCC or MCT cathodes secured on the TEP holder/mixing component (rotatable shaft and divder), allowing sequential reduction-oxidation steps, each with a 15-minute retention time as optimized in the PE-TEP.

The lower (100 ppt) initial concentrations were used as a bigger challenge for mineralization by our system. These are the levels above the PFOA+PFOS limit of 70 ppt set by EPA in 2016 and were in effect during the award for this research. The goal of the flow-through reactor was to achieve concentrations below these limits. It is important to note that since our award and defined research goals, EPA's health advisories (published 06/2022) identified the concentration of chemicals in drinking water at or below, which adverse health effects are not anticipated to occur, which are 0.004 parts per trillion (ppt) for PFOA, 0.02 ppt for PFOS, 10 ppt for GenX chemicals, and 2,000 ppt for PFBS.

We compared the efficiencies of the PE-TEP, FC-TEP, and continuous flow reactor without any cell modifications and mixing components. The solely continuous flow reactor without any cell modifications or mixing components, where the position of the electrodes varied from in-line to perpendicular to the flow as a design example we proposed initially, showed no significant removal nor transformation of PFOA+PFOS under the same operating conditions of the retention time, flow, and currents as PE-TEP and FC-TEP. As expected, this was caused by a) limited mass transfer and b) significant bubble accumulation in TEP, which adds to the limitations of electrode surface availability for the reactions. This limitation was the biggest challenge in translating the treatment from batch to flow conditions. However, the FC-TEP approach provided the solution.

The removal efficiencies are similar between the PE-TEP and FC-TEP, but the short-chain PFAS byproducts generation is 10× lower by the FC-TEP. This indicates the improved mineralization process where PFOA and PFOS molecules. The translation of the design from batch to flow reactor caused certain operational differences that can influence the efficiency, in this case, improving the performance. One of the reasons for the improved mineralization rates in the FC-TEP vs. PE-TEP is an improved bubble accumulation control under combined flow and mixing processes, which was evident by voltage monitoring during the treatment.

The 1.7 kWh/m³ energy use by the FC-TEP shows a minimum of 50% less energy use than some of the other efficient electrochemical systems for PFAS removal reported by date. The reported use energy for electrochemical oxidation processes ranges from 3.6 kWh/m³ using Ti₄O₇-electro oxidation compared to 19.9 kWh/m³ for BDD electrodes. Reported values significantly vary depending on the resources, as some report >300 kWh/m³ in energy consumption.

While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, terms such as “first,” “second,” “third,” “upper,” “lower,” “bottom,” “top,” etc. are used merely as labels, and are not intended to impose numerical or positional requirements on their objects. Further, the limitations of the following claims are not written in means-plus-function format and are not intended to be interpreted as such, unless and until such claim limitations expressly use the phrase “means for” followed by a statement of function void of further structure.

This written description uses examples to disclose several embodiments of the invention, including the best mode, and also to enable one of ordinary skill in the art to practice the embodiments of invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described invention, without departing from the spirit and scope of the invention herein involved, it is intended that all of the subject matter of the above description shown in the accompanying drawings shall be interpreted merely as examples illustrating the inventive concept herein and shall not be construed as limiting the invention.

1. An apparatus for treating PFAS-contaminated fluid comprising:
a housing having an inlet to receive untreated fluid at a first distal end and an outlet for removal of treated fluid at a second distal end, the housing having an open interior;
a slip ring attached to the second distal end;
a rotatable shaft located within the open interior, the rotatable shaft electrically connected to the slip ring;
at least one reduction-promoting cathode and anode pair disposed on the rotatable shaft;
at least one oxidation-promoting cathode and anode pair disposed on the rotatable shaft; and
wherein, in use, the at least one reduction-promoting cathode and anode pair and the at least one oxidation-promoting cathode and anode pair are rotated to mix the untreated fluid;
wherein a reductive process created by the at least one reduction-promoting cathode and anode pair along with an oxidative process created by the at least one oxidation-promoting cathode and anode pair to facilitate degradation of PFAS in the untreated fluid.

2. The apparatus of claim 1 further comprising:
an impeller operatively connected to the rotatable shaft, the impeller located proximate to the inlet;
wherein, in use, untreated fluid enters the inlet and rotates the impeller which rotates at least one reduction-promoting cathode and anode pair and the at least one oxidation-promoting cathode and anode pair to mix the untreated fluid.

3. The apparatus of claim 1 wherein the at least one reduction-promoting cathode and anode pair and/or the at least one oxidation-promoting cathode and anode pair are configured as blades that are attached to the rotatable shaft.

4. The apparatus of claim 1 wherein the at least one reduction-promoting cathode and anode pair and/or the at least one oxidation-promoting cathode and anode pair comprise:
a perforated divider separating an anode from a cathode.

5. The apparatus of claim 3 wherein the cathode and anode are mesh or fabric.

6. The apparatus of claim 1 wherein the at least one reduction-promoting cathode and anode pair are two blades spaced apart on the rotatable shaft, each blade including a cathode and anode.

7. The apparatus of claim 1 wherein the at least one oxidation-promoting cathode and anode pair are two blades spaced apart on the rotatable shaft, each blade including a cathode and anode.

8. The apparatus of claim 1 further comprising:
a power source electrically connected to the at least one reduction-promoting cathode and anode pair and to the at least one oxidation-promoting cathode and anode pair.

9. The apparatus of claim 1, wherein a cathode of the at least one reduction-promoting cathode and anode pair comprises a catalyst-coated carbon-based cathode.

10. The apparatus of claim 9, wherein the catalyst-coated carbon-based cathode provides catalytic activity towards a hydrogen evolution reaction and hydrodefluorination.

11. The apparatus of claim 1, wherein a cathode of the at least one oxidation-promoting cathode and anode pair comprises a modified carbon-based cathode.

12. The apparatus of claim 11, wherein the modified carbon-based cathode includes an oxygen-doped carbon material with functional groups selected to provide an electro-Fenton-like reaction.

13. The apparatus of claim 1, wherein the anodes of the at least one reduction-promoting cathode and anode pair and/or the at least one oxidation-promoting cathode and anode comprise TiMMO.

14. A method for electrochemical treatment of fluid containing PFAS, the method comprising:
introducing an untreated fluid containing PFAS into an open interior of a housing via an inlet; and
rotating a shaft located within the housing the shaft being operatively connected to a slip ring and containing a reduction-promoting cathode and anode pair and an oxidation-promoting cathode and anode pair;
applying an electric field to the reduction-promoting cathode and anode pair; and
applying an electric field to the oxidation-promoting cathode and anode pair;
wherein a reductive process created by the reduction-promoting cathode and anode pair followed by an oxidative process created by the oxidation-promoting cathode and anode pair to facilitate degradation of the PFAS in the untreated fluid.

15. The method of claim 14 wherein the shaft comprises an impeller located proximate to the inlet;
wherein introducing the untreated fluid into the open interior rotates the impeller which rotates the reduction-promoting cathode and anode pair and the oxidation-promoting cathode and anode pair.

16. The method of claim 14 wherein the reduction-promoting cathode and anode pair and/or the oxidation-promoting cathode and anode pair are configured as blades that are attached to the shaft.

17. The method of claim 14 further comprising a step of:
removing treated fluid from the housing via an outlet.

18. A system for electrochemical treatment of PFAS containing fluid comprising:
a housing having an inlet to receive untreated fluid at a first distal end and a outlet for removal of treated fluid at a second distal end, the housing having an open interior;
a slip ring attached to the second distal end of the housing;
a rotatable shaft located within the open interior, the rotatable shaft electrically connected to the slip ring;
at least one reduction-promoting cathode and anode pair disposed on the rotatable shaft;
at least one oxidation-promoting cathode and anode disposed on the rotatable shaft;
a pump configured to pump untreated fluid through the inlet into the open interior of the housing;
a DC power source electrically connected to the at least one reduction-promoting cathode and anode pair and the at least one oxidation-promoting cathode and anode pair via the slip ring; and
wherein, in use, the at least one reduction-promoting cathode and anode pair and the at least one oxidation-promoting cathode and anode pair are rotated to mix the untreated fluid;
wherein a reductive process created by the at least one reduction-promoting cathode and anode pair along with an oxidative process created by the at least one oxidation-promoting cathode and anode pair to facilitate degradation of PFAS in the untreated fluid.

19. The system of claim 18 further comprising:
an impeller operatively connected to the rotatable shaft, the impeller located proximate to the inlet;
wherein, in use, untreated fluid enters the inlet and rotates the impeller which rotates at least one reduction-promoting cathode and anode pair and the at least one oxidation-promoting cathode and anode pair to mix the untreated fluid.
